(19) United States
(12) Patent Application Publication
(10) Pub. No.: US 2007/0207833 A1
(43) Pub. Date: Sep. 6, 2007

(54) Bluetooth cordless phone

(75) Inventors: Meng Chyi Tsai, Taipei City (TW); Wen Chi Su, Taipei City (TW)

Correspondence Address: TROXELL LAW OFFICE PLLC;ONE SKYLINE PLACE, SUITE 1404, 5205 LEESBURG PIKE, FALLS CHURCH, VA, 22041, US

(73) Assignee: HETRONIC COMMUNICATIONS INC.

(21) Appl. No.: 11/647,165

(22) Filed: Dec. 29, 2006

(30) Foreign Application Priority Data
Mar. 1, 2006 (TW) 095200094

(51) Int. Cl. H04M 1/00

(52) U.S. Cl. 455/556.1

(57) ABSTRACT

The present invention relates to a Bluetooth cordless phone, which comprises: a Bluetooth base set that has a main body; and a Bluetooth remote set that may be separately disposed on the main body. Wherein, the main body comprises a compartment, a first opening, a second opening, and a third opening. A printed circuit board (PCB) is disposed inside the compartment, and the PCB further comprises at least a Bluetooth module and a hook that is exposed to the first opening. The Bluetooth remote set comprises at least a main body, a Bluetooth module, a microphone, a speaker, a battery, and a TALK button. When the Bluetooth cordless phone is being used, first the Bluetooth remote set is disposed in the main body of the Bluetooth base set for pairing. Once there is an incoming call, the user can press the TALK button such that the Bluetooth base set can control and cut off the hook in order to receive the incoming call.

### BACKGROUND OF THE INVENTION

1. Field of the Invention

The present invention relates to a Bluetooth cordless phone, and more particularly to a Bluetooth cordless phone that can be hung on the user's ear for inter-phone communication.

2. Description of the Related Art

A typical cordless phone usually has a base set and at least a remote set with a frequency of 27 MHz or 2.4 GHz in complying with Digital Enhanced Cordless Telecommunications (DECT) standard. Normally, the remote set is placed on the base set for charging the battery. In case there is an incoming call, the user can pick up the remote set and press the TALK button to talk, thus it is very convenient for the users. However, since the remote set is not made as a compact size, one of the disadvantages is that the user needs to hold the phone set with one hand and use the other hand to do other tasks, which is quite inconvenient.

Therefore, with many years of working experiences in product development and marketing for telecommunication products, the author of the present invention had dedicated himself in research and development of a new “Bluetooth cordless phone” disclosed in the present invention to overcome the shortcoming of the conventional cordless phone mentioned above.

### SUMMARY OF THE INVENTION

Therefore, it is a primary objective of the present invention to provide a Bluetooth cordless phone. The Bluetooth cordless phone can be hung on the user's ear for inter-phone communication without interrupting the user's task while the user is using this Bluetooth cordless phone.

To achieve the foregoing objective, a Bluetooth cordless phone provided by the present invention comprises: a Bluetooth base set that has a main body; and a Bluetooth remote set that may be separately disposed on the main body. Wherein, the main body comprises a compartment, a first opening, a second opening, and a third opening. A printed circuit board (PCB) is disposed inside the compartment, and the PCB further comprises at least a Bluetooth module and a hook that is exposed to the first opening. The Bluetooth remote set comprises at least a main body, a Bluetooth module, a microphone, a speaker, a battery, and a TALK button. When this Bluetooth cordless phone is being used, first the Bluetooth remote set is disposed in the main body of the Bluetooth base set for pairing and charging. Once there is an incoming call, the user can press the TALK button such that the Bluetooth base set can control and cut lead off the phone set hook in order to answer the incoming call. And press the TALK button again to hook the incoming call.

### BRIEF DESCRIPTION OF THE DRAWINGS

The accompanying drawings are included to provide a further understanding of the invention, and are incorporated in and constitute a portion of this specification. The drawings illustrate embodiments of the invention, and together with the description, serve to explain the principles of the invention.

FIG. 1 is a schematic diagram of a Bluetooth cordless phone according to a preferred embodiment of the present invention.

FIG. 2 is a schematic block diagram of a base set according to a preferred embodiment of the present invention.

FIG. 3 is a schematic block diagram of a Bluetooth remote set according to a preferred embodiment of the present invention.

FIG. 4 is a schematic block diagram of a hook controlling device that is further comprised in the present invention.

### DETAILED DESCRIPTION OF THE PREFERRED EMBODIMENTS

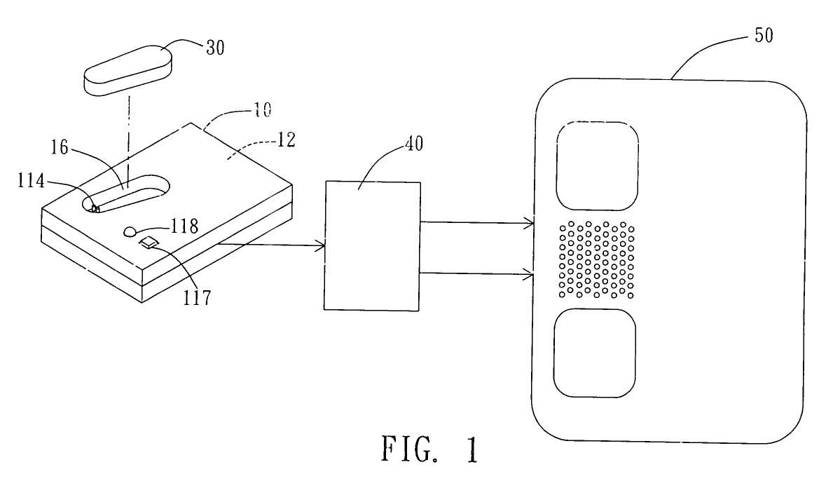

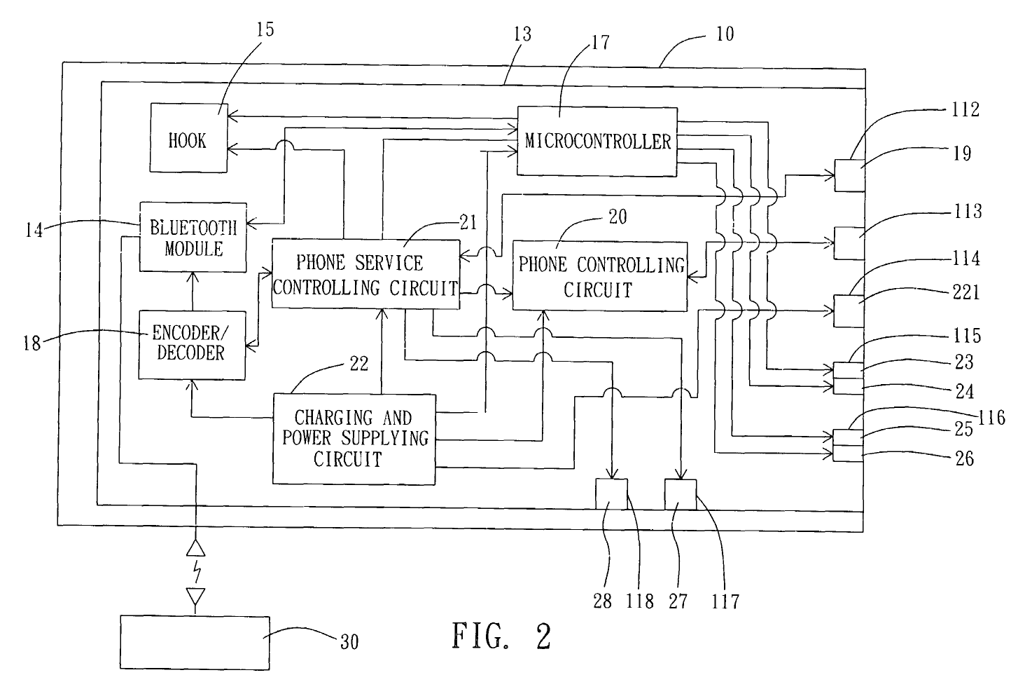

Referring to FIG. 1 and FIG. 2, wherein FIG. 1 is a schematic diagram of a Bluetooth cordless phone according to a preferred embodiment of the present invention. As shown in FIG. 1, the Bluetooth cordless phone of the present invention comprises a Bluetooth base set 10 and a Bluetooth remote set 30.

The Bluetooth base set 10 has a main body 11, and the main body 11 comprises a compartment 12, a first opening 111, a second opening 112, and a third opening 113 (please refer to FIG. 2). A printed circuit board (PCB) 13 is disposed inside the compartment 12 (please refer to FIG. 2), and the PCB 13 further comprises at least a Bluetooth module 14 and a hook 15 that is exposed to the first opening 111. As for the detailed description of the Bluetooth module 14 and the hook 15, please refer to the description of FIG. 2.

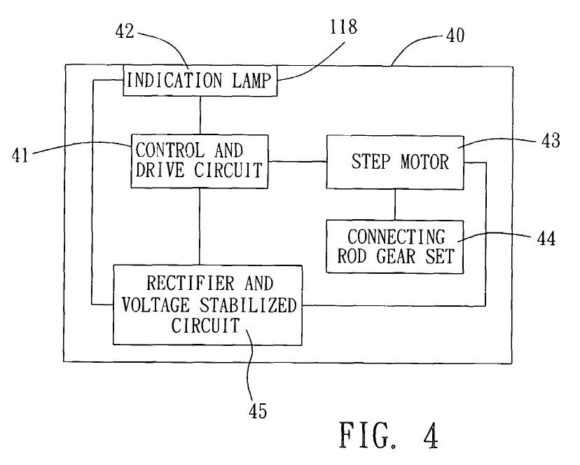

In addition, the main body 11 of the Bluetooth base set 10 further comprises an empty hole 16, a plurality of fourth openings 114, a plurality of fifth openings 115, a plurality of sixth openings 116, a plurality of seventh openings 117, and a plurality of eighth openings 118 (please refer to FIG. 4). Wherein, the curve-shaped empty hole 16 is located on the surface of the main body 11, and the plurality of fourth openings 114 is located inside the empty hole 16 for placing the Bluetooth remote set 30.

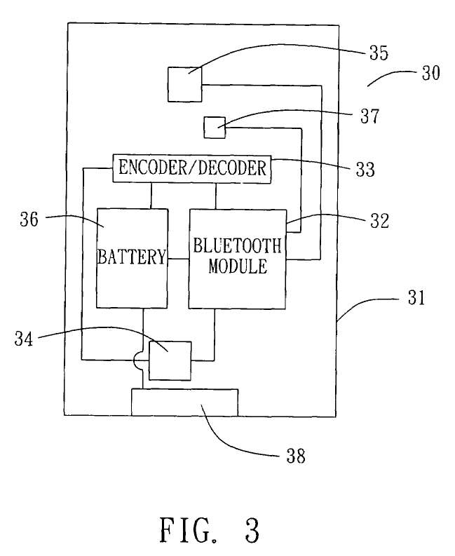

The Bluetooth remote set 30 may be separately disposed on the main body 11. The shape of the Bluetooth remote set 30 is similar to the general Bluetooth earset, thus it can be easily hung on the user's ear. The Bluetooth remote set 30 at least comprises a main body 31, a Bluetooth module 32, an encoder/decoder 33, a microphone 34, a speaker 35, a battery 36, and a TALK button 37. As for the detailed description of the Bluetooth remote set 30, please refer to the description of FIG. 3.

When the Bluetooth cordless phone is being used, first the Bluetooth remote set 30 is placed in the main body 11 of the Bluetooth base set 10 for pairing. Once there is an incoming call from a phone set 50, the user can press the TALK button 37 such that the Bluetooth base set 10 can control and cut off the hook 15 in order to receive the incoming call. Accordingly, the disadvantage of the conventional cordless phone is solved.

FIG. 2 is a schematic block diagram of a base set 10 according to a preferred embodiment of the present invention. In addition to the Bluetooth module 14 and hook 15, the Bluetooth base set 10 further comprises a microcontroller 17, an encoder/decoder 18, a digital headphone phone jack 19, a phone controlling circuit 20, a phone service controlling circuit 21, and a charging and power supplying circuit 22.

The Bluetooth module 14 is disposed on the PCB 13 to receive the voice signal sent by the Bluetooth remote set 30 and vice versa.

The hook 15 is indeed a hook for the general phone set 50. When the hook 15 is depressed, it indicates that the headphone (not shown) is placed on it, therefore the phone set 50 is in a “waiting for incoming call” state. Once the hook 15 is released, it indicates that the headphone (not shown) is picked up, thus the phone set 50 is in a “talking” state.

The microcontroller 17 is coupled to the Bluetooth module 14 to control the hook 15, to send/receive the voice signal of the Bluetooth module 14, and further send related control signals to control the Bluetooth base set 10. In addition, the microcontroller 17 can further send an AT-command to the Bluetooth module 14 for communication.

The encoder/decoder 18 is coupled to the Bluetooth module 14 and the phone service controlling circuit 21 for sending/receiving the voice signal and performing the encode and decode operation. Preferably, the encoder/decoder 18 is a PCM encoder/decoder and may further comprise an echo elimination function.

The digital headphone phone jack 19 is coupled to a digital headphone (not shown) and exposed to the second opening 112 for detecting a ring signal, a hang up signal, and a digital voice signal from a digital phone line (not shown). Wherein, the ring signal may be input to the phone service controlling circuit 21.

The phone controlling circuit 20 is coupled to an analog phone line (not shown) through the third opening 113 for detecting a ring signal, a hang up signal, and an analog voice signal from the analog phone line. Wherein, the ring signal may be input to the phone service controlling circuit 21.

The phone service controlling circuit 21 is coupled to the microcontroller 17, the digital headphone phone jack 19, and the phone controlling circuit 20 for performing the pairing, the voice connection, and the hook control operations. In addition, the phone service controlling circuit 21 also selectively outputs either the digital voice signal or the analog voice signal to the encoder/decoder 18 for performing the encode and decode operation. Wherein, the pairing function is performed through the following method. The user uses a dip switch (not shown) to respectively adjust the address (ID) of the Media Access Control (MAC) layer of the Bluetooth module 14 and the Bluetooth module 32 and to store the addresses (IDs) in the microcontroller 17. Alternatively, the Bluetooth module 14 may comprise a circuit that can read the MAC layer address (ID) of the Bluetooth module 32 for respectively adjusting the MAC layer address (ID) of the Bluetooth remote set 30. When performing the pairing operation, first the Bluetooth module 32 of the Bluetooth remote set 30 transmits its MAC address to the Bluetooth base set 10. The MAC address is received by the Bluetooth module 14 and then transmitted to the microcontroller 17. Afterwards, the MAC address is compared by the microcontroller 17. If the MAC address is matched, the Bluetooth remote set 30 is able to communicate with the Bluetooth base set 10. Otherwise, the Bluetooth remote set 30 is unable to communicate with the Bluetooth base set 10.

The charging and power supplying circuit 22 is respectively coupled to the microcontroller 17, the encoder/decoder 18, the phone controlling circuit 20, and the phone service controlling circuit 21 for supplying the desired DC power. In addition, the charging and power supplying circuit 22 further comprises a plurality of contacts 221, which is exposed to the plurality of fourth openings 114 for charging the Bluetooth remote set 30.

Referring to FIG. 1 and FIG. 2, the Bluetooth base set 10 of the present invention further comprises a pairing button 23 and an ON/OFF button 24, which are coupled to the microcontroller 17 and respectively exposed to the plurality of fifth openings 115 for performing the Bluetooth pairing and the press or release of the power of the Bluetooth base set 10.

In addition, the Bluetooth base set 10 further comprises a mute switch 25 and a volume control switch 26, which are coupled to the microcontroller 17 and respectively exposed to the plurality of sixth openings 116 for controlling the mute function and adjusting the volume.

In addition, the Bluetooth base set 10 further comprises a mode selection switch 27, which is coupled to the phone service controlling circuit 21 and respectively exposed to the plurality of seventh openings 117 for selecting the digital phone or the analog phone.

In addition, the Bluetooth base set 10 further comprises a plurality of indication lamps 28, which is coupled to the microcontroller 17 and respectively exposed to the plurality of eighth openings 118 for displaying the Bluetooth voice connection and pairing status.

FIG. 3 is a schematic block diagram of a Bluetooth remote set 30 according to a preferred embodiment of the present invention. As shown in the drawing, the Bluetooth remote set 30 comprises a Bluetooth module 32, an encoder/decoder 33, a microphone 34, a speaker 35, a battery 36, and a TALK button 37.

Wherein, the Bluetooth module 32, the encoder/decoder 33, the microphone 35, the battery 36, and the TALK button 37 are respectively disposed inside the main body 31. The encoder/decoder 33, the microphone 34, the speaker 35, and the TALK button 37 are respectively coupled to the Bluetooth module 32, such that the voice signal input by the user through the microphone 34 can be first encoded by the encoder/decoder 33 and then transmitted through the Bluetooth module 32 and vice versa. The battery 36 is coupled to the encoder/decoder 33 and the Bluetooth module 32 to supply the desired power. Wherein, the battery 36 includes, but is not limited to be a chargeable battery. The Bluetooth remote set 30 further comprises a plurality of contacts 38 that are exposed to the main body 31, such that the contacts 38 can be contacted with the plurality of contacts 221 of the Bluetooth base set 10 to charge the battery 36.

FIG. 4 is a schematic block diagram of a hook controlling device 40 that is further comprised in the present invention. As shown in the drawing, in the Bluetooth base set 10 of the present invention, the hook 15 can be cut off either manually controlled by the user or by an automatic way. When the hook 15 is manually controlled by the user, after the user is finished talking, the user can manually press the hook 15, such that the Bluetooth base set 10 ends the talk and stays in a standby mode. When the hook 15 is controlled automatically, it is required to embed or externally configure a hook controlling device 40 to control the state of the hook 15. As shown in FIG. 4, in the present embodiment, the hook controlling device 40 is embedded in the Bluetooth base set 10, which serves as an example but is not limited to this.

The hook controlling device 40 is disposed inside the main body 11 of the Bluetooth base set 10 for receiving the control from the phone service controlling circuit 21 to automatically turn on and cut off the hook 15. The hook controlling device 40 further comprises a control and drive circuit 41, an indication lamp 42, a step motor 43, a connecting rod gear set 44, and a rectifier and voltage stabilized circuit 45.

Wherein, the control and drive circuit 41 is coupled to the phone service controlling circuit 21 to control and drive the ON/OFF of the step motor 43.

The indication lamp 42 is coupled to the control and drive circuit 41 and exposed to the opening 118 for indicating the operation state of the hook controlling device 40. For example, the indication lamp 42 is turned off when the hook 15 is depressed and turned on when the hook 15 is released.

The step motor 43 is coupled to the control and drive circuit 41 for receiving the control and drive from the control and drive circuit 41, so as to control the connecting rod gear set 44.

The connecting rod gear set 44 is coupled to the step motor 43. The connecting rod gear set 44 is a connecting rod gear set mechanism for receiving the drive from the step motor 43 to move it up and down, so as to control the press and release of the hook 15.

The rectifier and voltage stabilized circuit 45 is coupled to an external DC power (not shown) for rectifying and stabling the voltage and respectively supplying DC voltage to the control and drive circuit 41, the indication lamp 42, and the step motor 43, so as to supply the desired power.

In summary, comparing with the conventional cordless phone, the Bluetooth remote set 30 of the Bluetooth cordless phone provided by the present invention can be hung on the user's ear for performing the inter-phone communication. Accordingly, the present invention can facilitate the user in using the cordless phone and not interrupt the user's task, so as to resolve the disadvantage of the conventional cordless phone.

Although the invention has been described with reference to a particular embodiment thereof, it will be apparent to one of the ordinary skills in the art that modifications to the described embodiment may be made without departing from the spirit of the invention. Accordingly, the scope of the invention will be defined by the attached claims not by the above detailed description.

What is claimed is:

1. A Bluetooth cordless phone, comprising:
a Bluetooth base set, having a main body, wherein said main body comprising a compartment, a first opening, a second opening, and a third opening, an empty hole is located on an outer side of said main body, a printed circuit board (PCB) is disposed inside said compartment, said PCB further comprises a Bluetooth module and a hook, and said hook is exposed to said first opening; and
a Bluetooth remote set, being separately disposed on said main body, at least comprising a main body, a Bluetooth module, an encoder/coder, a microphone, a speaker, a battery, and a TALK button;
wherein, when said Bluetooth cordless phone is being used, first said Bluetooth remote set can be placed in said main body of said Bluetooth base set for pairing, when there is an incoming call, a user can press said TALK button, such that said Bluetooth base set can control and cut off said hook and start to talk.

2. The Bluetooth cordless phone of claim 1, wherein said Bluetooth base set further comprises:
a microcontroller, being coupled to said Bluetooth module to control a hook controlling device, to send/receive a voice signal of said Bluetooth module, and to send a related control signal to control said Bluetooth base set;
an encoder/decoder, being coupled to said Bluetooth module to encode and decode said sent/received voice signal;
a digital headphone phone jack, being coupled to a digital headphone and being exposed to said second opening for detecting a ring signal, a hang up signal, and a digital voice signal from a digital phone line, wherein said ring signal is input to a phone service controlling circuit;
a phone controlling circuit, being coupled to an analog phone line through said third opening for detecting a ring signal, a hang up signal, and an analog voice signal from said analog phone line, wherein said ring signal is input to said phone service controlling circuit;
said phone service controlling circuit, being coupled to said microcontroller, said digital headphone phone jack, and said phone controlling circuit for receiving a control signal from said microcontroller in order to perform a pairing, a voice connection, and a hook control, and to selectively output either said digital voice signal or said analog voice signal to said encoder/decoder; and
a charging and power supplying circuit, being respectively coupled to said microcontroller, said encoder/decoder, said phone controlling circuit, and said phone service controlling circuit for supplying a desired DC power.

3. The Bluetooth cordless phone of claim 2, wherein the encoder/decoder is a PCM encoder/decoder, and further comprises an echo elimination function.

4. The Bluetooth cordless phone of claim 2, wherein said main body of said Bluetooth base set further comprises a plurality of fourth openings, a plurality of fifth openings, a plurality of sixth openings, a plurality of seventh openings, and a plurality of openings; wherein said empty hole is located at a surface of said main body, and said plurality of fourth openings is located inside said empty hole for placing said Bluetooth remote set.

5. The Bluetooth cordless phone of claim 4, wherein said Bluetooth remote set can be hung on one ear of a user.

6. The Bluetooth cordless phone of claim 4, wherein said charging and power supplying circuit further comprises a plurality of contacts that are exposed to said plurality of fourth openings for charging said Bluetooth remote set.

7. The Bluetooth cordless phone of claim 4, wherein said Bluetooth base set further comprises an ON/OFF button, which are coupled to said microcontroller and respectively exposed to said plurality of fifth openings for performing a Bluetooth pairing and a press or release of said power of said Bluetooth base set.

8. The Bluetooth cordless phone of claim 4, wherein said Bluetooth base set further comprises a mute switch and a volume control switch, which are coupled to said microcontroller and respectively exposed to said plurality of sixth openings for controlling a mute function and adjusting a talk volume.

9. The Bluetooth cordless phone of claim 4, wherein said Bluetooth base set further comprises a mode selection switch, which is coupled to said phone service controlling circuit and respectively exposed to said plurality of seventh openings for selecting either a digital phone or an analog phone.

10. The Bluetooth cordless phone of claim 4, wherein said Bluetooth base set further comprises a plurality of indication lamps, which is coupled to said microcontroller and respectively exposed to said plurality of openings for displaying a Bluetooth voice connection and pairing status.

11. The Bluetooth cordless phone of claim 4, wherein said battery of said Bluetooth remote set is a chargeable battery, and said Bluetooth remote set further comprises a plurality of contacts that is exposed to said main body, such that said plurality of contacts of said Bluetooth remote set can be contacted with said plurality of contacts of said Bluetooth base set in order to charge said battery.

12. The Bluetooth cordless phone of claim 1, wherein said hook of said Bluetooth base set can be manually cut off by a user or by an automatic way.

13. The Bluetooth cordless phone of claim 12, wherein in said user manual control way, after said user is finishing a talking, said user can manually press said hook, such that said Bluetooth base set ends said talk and stays in a standby mode.

14. The Bluetooth cordless phone of claim 12, wherein said automatic control way further comprises a hook controlling device, which is disposed inside said main body of said Bluetooth base set or said main body of said phone set for receiving a control from said phone service controlling circuit to automatically turn on or cut off said hook.

15. The Bluetooth cordless phone of claim 14, wherein said hook controlling device further comprises:
a control and drive circuit, being coupled to said phone service controlling circuit to control and drive a step motor;
an indication lamp, being coupled to said control and drive circuit for indicating an operation status of said hook controlling device;
said step motor, being coupled to said control and drive circuit for controlling a connecting rod gear set;
said connecting rod gear set, being coupled to said step motor for receiving a drive from said step motor in order to control a press or release of said hook; and
a rectifier and voltage stabilized circuit, being coupled to said control and drive circuit, said indication lamp, and said step motor for supplying a desired power.

16. The Bluetooth cordless phone of claim 1, wherein said Bluetooth base set comprises a circuit that can read a Bluetooth Device address (BD Address) of said Bluetooth remote set for respectively adjusting said Bluetooth Device address (BD Address) of said Bluetooth remote set. And auto paring connect Bluetooth remote set.
